(19) United States
(12) Patent Application Publication
(10) Pub. No.: US 2024/0271805 A1
(43) Pub. Date: Aug. 15, 2024

(54) COMPOSITE CATALYST FILTER, FILTERING SYSTEM INCLUDING THE SAME, AND METHOD OF PREPARING THE COMPOSITE CATALYST FILTER

(71) Applicant: Samsung Electronics Co., Ltd., Suwon-si (KR)

(72) Inventors: Hyeonsu HEO, Suwon-si (KR); Jongmin LEE, Suwon-si (KR); Wooyul KIM, Suwon-si (KR); Hyun Chul LEE, Suwon-si (KR); Cheolwoo PARK, Suwon-si (KR); Gahye SHIN, Suwon-si (KR)

(21) Appl. No.: 18/232,452

(22) Filed: Aug. 10, 2023

(30) Foreign Application Priority Data
Feb. 9, 2023 (KR) 10-2023-0031362

(51) Int. Cl. F24F 8/167; B01D 39/20; B01J 21/06; B01J 23/42; B01J 29/40; B01J 35/00; B01J 35/02; F24F 8/108

(52) U.S. Cl. CPC F24F 8/167; B01D 39/2068; B01J 21/063; B01J 23/42; B01J 29/40; B01J 35/19; B01J 35/39; B01J 35/40; F24F 8/108; B01D 2239/0478; B01D 2257/702

(57) ABSTRACT

A composite catalyst filter includes a porous filter substrate, and particles of at least one type of catalyst on a surface of the porous filter substrate. The particles of the catalyst include particles of a photocatalyst, and particles of at least one type of adsorbent and oxidation catalyst.

This application claims priority to Korean Patent Application No. 10-2023-0031362, filed on Mar. 9, 2023, and all the benefits accruing therefrom under 35 U.S.C. § 119, the content of which in its entirety is herein incorporated by reference.

### BACKGROUND

### 1. Field

The disclosure relates to a composite catalyst filter, a filtering system including the same, and a method of preparing the composite catalyst filter.

### 2. Description of the Related Art

In the art, methods of adsorbing/removing gaseous pollutants by applying adsorbents having relatively large specific areas (e.g., activated carbon) to air-purifying filters are used to remove pollutants from the air. As another method, a method of using an oxidation catalyst is used to remove pollutants by oxidation occurring at contact sites between gases and an oxidation catalyst coated on a surface of a honeycomb substrate. Recently, methods of using a photocatalyst (e.g.: TiO₂) are being used to remove pollutants in the air by oxidation/reduction induced by electrons and holes generated by the photocatalyst upon receiving light with a predetermined amount of energy or more.

### SUMMARY

However, methods of adsorbing/removing pollutants may cause secondary contamination, or performance of an adsorbent may rapidly deteriorate in moist conditions. Methods using an oxidation catalyst have relatively low efficiency because only a catalyst close to airflow participates in a reaction. In addition, methods using a photocatalyst are limited because the catalyst is activated only in an area exposed to light.

Provided is a composite catalyst filter having an increased air pollutant removal rate.

Provided is a filtering system including the composite catalyst filter.

Provided is a method of preparing the composite catalyst filter.

Additional features will be set forth in part in the description which follows and, in part, will be apparent from the description, or may be learned by practice of the presented embodiments of the disclosure.

According to an embodiment of the disclosure, a composite catalyst filter includes a porous filter substrate, and particles of at least one type of catalyst on a surface of the porous filter substrate. The particles of the catalyst include particles of a photocatalyst, and particles of at least one type of adsorbent and oxidation catalyst.

According to another embodiment, a composite catalyst filter for removing pollutants from pollutant-containing air includes a porous filter substrate, and particles of at least one type of adsorbent and oxidation catalyst and particles of a photocatalyst formed on a surface of the porous filter substrate to contact the pollutants in the air.

According to another embodiment of the disclosure, a filtering system includes a composite catalyst filter, and a light source configured to activate a catalyst of the composite catalyst filter. The composite catalyst filter includes a porous filter substrate, and particles of at least one type of catalyst on a surface of the porous filter substrate. The particles of the catalyst include particles of a photocatalyst, and particles of at least one type of adsorbent and oxidation catalyst.

According to another embodiment of the disclosure, a method of preparing the above-described composite catalyst filter includes providing a porous filter substrate; preparing an oxidation catalyst coating solution and a photocatalyst coating solution, respectively; coating the porous filter substrate with the oxidation catalyst coating solution and the photocatalyst coating solution by immersing the porous filter substrate in the oxidation catalyst coating solution and the photocatalyst coating solution; and drying and heat-treating the porous filter substrate coated with coating solutions.

### BRIEF DESCRIPTION OF THE DRAWINGS

The above and other features and advantages of illustrative embodiments of the disclosure will be more apparent from the following description taken in conjunction with the accompanying drawings, in which:

FIG. 1 is a schematic diagram of a comparative example of a filtering system including an oxidation catalyst structure.

FIG. 2 is a schematic diagram of an embodiment of a filtering system including a composite catalyst filter.

FIG. 3 is a schematic diagram of another embodiment of a filtering system including a composite catalyst filter.

FIG. 4 is a perspective diagram of an embodiment of a composite catalyst filter.

FIG. 5 is a front view of a surface through which unpurified air enters the composite catalyst filter of FIG. 4.

FIG. 6 is a front view of a surface through which purified air is discharged from the composite catalyst filter of FIG. 4.

FIG. 7 is a cross-sectional view of the composite catalyst filter of FIG. 4 taken along line 4-4′.

FIG. 8 is a schematic diagram of a filtering system including a composite catalyst filter according to Example 1.

FIG. 9 is a schematic diagram illustrating a device used in an experiment for evaluating an HCHO removal rate according to Evaluation Example 1.

### DETAILED DESCRIPTION

Reference will now be made in detail to embodiments, illustrative embodiments of which are illustrated in the accompanying drawings, wherein like reference numerals refer to like elements throughout. In this regard, the illustrated embodiments may have different forms and should not be construed as being limited to the descriptions set forth herein. Accordingly, the embodiments are merely described below, by referring to the drawing figures, to explain features. As used herein, the term “and/or” includes any and all combinations of one or more of the associated listed items. Expressions such as “at least one of,” when preceding a list of elements, modify the entire list of elements and do not modify the individual elements of the list.

The inventive concept of the disclosure described below allows for various changes and numerous embodiments, particular embodiments will be illustrated in the drawings and described in detail in the written description. However, this is not intended to limit the disclosure to particular modes of practice, and it is to be appreciated that all modifications, equivalents, and substitutes that do not depart from the spirit and technical scope of the disclosure are encompassed in the disclosure.

The terms used herein are merely used to describe particular embodiments and are not intended to limit the disclosure. An expression used in the singular encompasses the expression of the plural, unless it has a clearly different meaning in the context.

Expressions such as “at least one of” or “one or more”, when preceding a list of elements, modify the entire list of elements and do not modify the individual elements of the list. As used herein, the term “combination” includes a mixture, an alloy, a reaction product, and the like unless otherwise stated. Throughout the specification, the term “include” in relation to an element does not preclude other elements but may further include another element, unless otherwise stated. Throughout the specification, terms “first”, “second”, and the like are used to distinguish one component from another, without indicating order, quantity, or importance. An expression used in the singular encompasses the expression of the plural, unless otherwise indicated or it has a clearly different meaning in the context. The term “or” refers to “and/or”, unless otherwise stated.

As used herein, the terms “an embodiment”, “embodiments”, and the like indicate that elements described with regard to an embodiment are included in at least one embodiment described in this specification and may or may not in other embodiments. In addition, it may be understood that the described elements are combined in any suitable manner in various embodiments.

Unless otherwise stated, all percentages, parts, ratios, and the like are based on weight. When an amount, concentration, or other value or parameter is given as either a range, preferred range or a list of upper preferable values and/or lower preferable values, this is to be understood as specifically disclosing all ranges formed from any pair of any upper range limit or preferred value and any lower range limit or preferred value, regardless of whether ranges are separately disclosed.

Where a range of numerical values is recited herein, unless otherwise stated, the range is intended to include the endpoints thereof, and all integers and fractions within the range. The scope of the disclosure is intended not to be limited by a specific value mentioned when a range is defined.

Unless otherwise stated, the unit “parts by weight” refers to a weight ratio of each component and the unit “parts by mass” refers to a converted solid content of a weight ratio of each component.

“About” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations or within +30%, 20%, 10%, or 5% of the stated value.

Unless otherwise defined, all terms (including technical and scientific terms) used herein have the same meaning as commonly understood by one of ordinary skill in the art to which this disclosure belongs. Also, it will be further understood that terms, such as those defined in commonly used dictionaries, should be interpreted as having a meaning that is consistent with their meaning in the context of the relevant art and will not be interpreted in an idealized or overly formal sense unless expressly so defined herein.

Embodiments will be described herein with reference to schematic cross-sectional view of ideal embodiments. Therefore, variations from the shapes of the illustrations as a result, for example, of manufacturing techniques and/or tolerances, are to be expected. Thus, embodiments should not be construed as limited to the particular shapes of regions illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the drawing figures are schematic in nature and their shapes are not intended to illustrate the actual shape of a region of a device and are not intended to limit the scope of claims.

Hereinafter, a composite catalyst filter, a filtering system including the same, and a method of preparing the composite catalyst filter in embodiments will be described in detail.

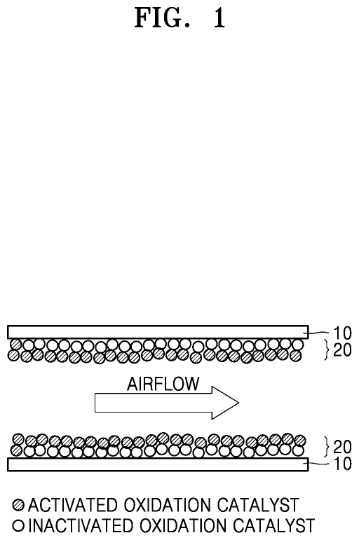

FIG. 1 is a schematic diagram of a comparative example of a filtering system including an oxidation catalyst structure. As shown in FIG. 1, an oxidation catalyst structure according to a comparative example has a structure in which an oxidation catalyst layer 20 is disposed on a surface of a porous substrate 10, e.g., a porous substrate having a honeycomb structure. The oxidation catalyst layer 20 includes two layers of oxidation catalyst particles disposed on the surface of the porous substrate 10 where air flows. Among the oxidation catalyst particles, oxidation catalyst particles of a second layer close to the airflow are activated by contact with air, but oxidation catalyst particles of a first layer not close to the airflow are not activated. As a thickness of the oxidation catalyst layer 20 increases, the number of oxidation catalyst particles not close to the airflow increases, thereby enlarging an inactivated region. In a photocatalyst structure in which photocatalyst particles are coated on a surface of a porous substrate, the photocatalyst particles are activated only in an area exposed to energy.

Therefore, a filtering system including an oxidation catalyst structure or a photocatalyst structure has a relatively low air pollutant removal rate because activated catalyst particles are distributed in limited areas.

A catalyst structure in an embodiment is a composite catalyst filter. The composite catalyst filter includes a porous filter substrate, and particles of at least one type of catalyst on a surface of the porous filter substrate wherein the particles of the catalyst include particles of a photocatalyst, and particles of at least one type of adsorbent and oxidation catalyst. In the description, different types may mean chemical elements or catalytic function different from each other. The porous filter substrate includes a first surface parallel to an air inflow direction, and a second surface perpendicularly in contact with the first surface, and a groove having an inlet at one side through which air is introduced is defined in the porous filter substrate. The catalysts particles are disposed on the first and second surfaces of the porous filter substrate. In the composite catalyst filter, almost all of the catalyst particles are activated and participate in catalytic reaction, and thus an air pollutant removal rate may be increased.

The porous filter substrate may include or consist of a material such as ceramic, metal, polymer, plastic, non-woven fabric, activated carbon, or glass fiber, but is not limited thereto. In an embodiment, the porous filter substrate may be a porous ceramic filter, for example. The porous ceramic filter may not be replaced but reused because an air pollutant removal rate is not rapidly decreased even in a highly humid environment.

The porous filter substrate may have a porosity of about 5% to about 90%, e.g., a porosity of about 10% to about 90%, about 10% to about 85%, about 15% to about 80%, about 20% to about 80%, about 25% to about 75%, or about 30% to about 70%. The porosity may be adjusted in consideration of a material or thickness of a filter substrate, pore size, size of pollutants in the air, or the like. In an embodiment, the porous filter substrate may have pores with a uniform size and a porosity of about 30% to about 70%, for example.

The porous filter substrate may include an air-permeable wall through which air passes.

Air flowing from the inside of a groove of the porous filter substrate may pass through walls of the first and second surfaces and contact the catalyst particles disposed on the first and second surfaces. Almost all of the catalyst particles of this porous filter substrate may contact pollutant-containing air having passed through the walls of the porous filter substrate although adsorbent particles and/or oxidation catalyst particles are arranged in multiple layers. As a result, almost all of the catalyst particles may participate in catalytic reaction.

The porous filter substrate may be a porous single structure in which the first and second surfaces respectively parallel to each other are combined as one structure.

The porous filter substrate may include or consist of the same material as a whole, e.g., ceramic, metal, polymer, plastic, non-woven fabric, activated carbon, or glass fiber. The porous filter substrate, as a single structure, may include a plurality of first surfaces parallel to an air inflow direction, and a plurality of second surfaces perpendicularly in contact with the plurality of first surfaces, and a plurality of grooves having an inlet through which air is introduced may be defined in the porous filter substrate.

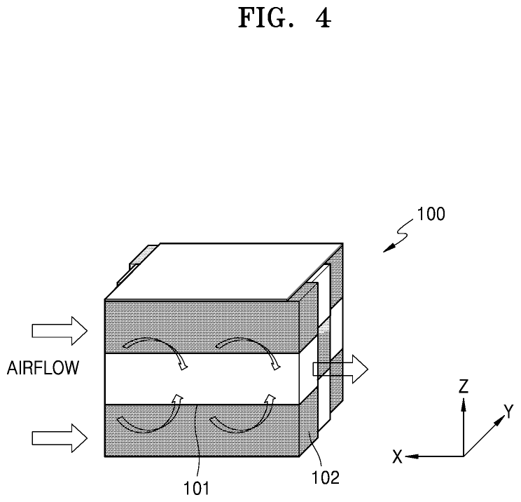

A composite catalyst filter and a filtering system including the same in an embodiment will be described in more detail with reference to FIGS. 4 to 7.

Referring to FIG. 4, a composite catalyst filter 100 includes an inlet surface through which unpurified air is introduced and an outlet surface through which purified air is discharged. A plurality of first grooves 110 each having an inlet close to the inlet surface through which unpurified air is introduced is defined in the composite catalyst filter 100 and the composite catalyst filter 100 includes a bottom close to the outlet surface through which purified air is discharged. The unpurified air is introduced into the composite catalyst filter 100 through the plurality of first grooves 110. The plurality of first grooves 110 may be regularly and/or periodically arranged. The plurality of first grooves 110 may be arranged parallel to each other.

The composite catalyst filter 100 includes a plurality of second surfaces 120S exposed to the inlet surface through which unpurified air is introduced. The plurality of second surfaces 120S is regularly arranged. The plurality of second surfaces 120S is arranged between the plurality of first grooves 110.

The plurality of second surfaces 120S is arranged to be spaced apart from each other between the plurality of first grooves 110 arranged to be spaced apart from each other in one direction along the surface of the inlet surface, e.g., in the X-axis direction and/or Z-axis direction. The plurality of first grooves 110 and the plurality of second surfaces 120S are alternately arranged in one direction along the surface of the inlet surface, e.g., in the X-axis direction and/or Z-axis direction. One first groove 110 is surrounded by four second surfaces 120S, and one second surface 120S is surrounded by four first grooves 110.

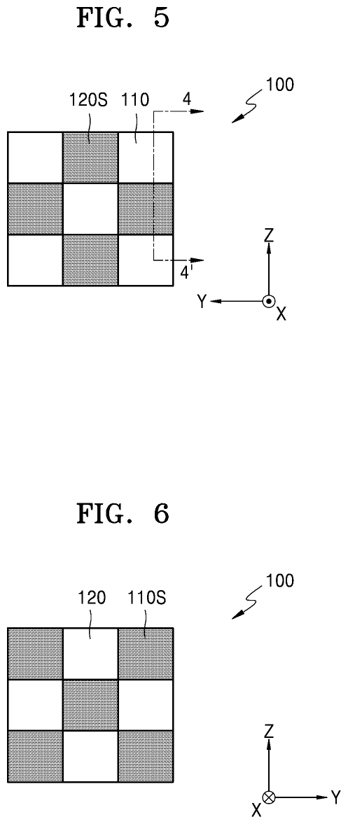

FIG. 5 is a front view of the composite catalyst filter 100 of FIG. 4, i.e., front view of the inlet surface. FIG. 6 is a rear view of the composite catalyst filter 100 of FIG. 4, i.e., front view of the outlet surface.

Referring to FIG. 5, a plurality of first grooves 110 is defined in the inlet surface of the composite catalyst filter 100 and the inlet surface of the composite catalyst filter 100 includes a plurality of second surfaces 120S. Referring to FIG. 6, a plurality of second grooves 120 is defined in the outlet surface of the composite catalyst filter 100 and the outlet surface of the composite catalyst filter 100 includes a plurality of first surfaces 110S. The plurality of second grooves 120 is outlets through which purified air is discharged. Purified air discharged through the second groove 120 may be air obtained after removing or degrading pollutants from the air to be purified and introduced through the first groove 110.

The plurality of second grooves 120 may be regularly and/or periodically arranged. The plurality of first surfaces 110S is regularly arranged. The plurality of second surfaces 120S is arranged between the plurality of second grooves 120.

The plurality of first surfaces 110S corresponds to the plurality of first grooves 110, and the plurality of second grooves 120 corresponds to the plurality of second surfaces 120S.

Referring to FIGS. 5 and 6, the first surface 110S serves as the bottom of the first groove 110, and the second surface 120S correspond to the bottom of the second groove 120.

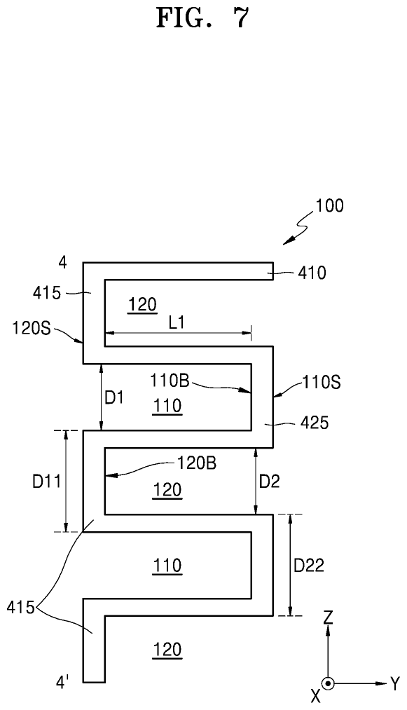

FIG. 7 is a cross-sectional view taken along line 4-4′ of FIG. 5.

Referring to FIG. 7, the composite catalyst filter 100 includes a plurality of horizontal areas 410 and a plurality of vertical areas 415 and 425. The plurality of horizontal areas 410 is arranged to be spaced apart from each other along the Z-axis direction. The Z-axis direction corresponds to the vertical direction. The plurality of horizontal areas 410 is arranged parallel to each other along the Y-axis direction. Lengths of the plurality of horizontal areas 410 are the same or different. The plurality of horizontal areas 410 is arranged between the plurality of vertical areas 415 and 425. The plurality of horizontal areas 410 is physically connected to each other via the plurality of vertical areas 415 and 425. The plurality of vertical areas 415 and 425 is arranged parallel to each other to be spaced apart from each other. The plurality of vertical areas 415 and 425 are arranged along the Z-axis direction to be spaced apart from each other. The Z-axis direction corresponds to the vertical direction. The plurality of vertical areas 415 and 425 are arranged parallel to each other along the Y-axis direction. Lengths of the plurality of vertical areas 415 and 425 are the same or different. The plurality of vertical areas 415 and 425 is arranged between the plurality of horizontal areas 410. The plurality of vertical areas 415 and 425 is physically connected to each other via the plurality of horizontal areas 410. The plurality of vertical areas 415 and 425 includes a plurality of first vertical areas 415 and a plurality of second vertical areas 425. The plurality of first vertical areas 415 and the plurality of second vertical areas 425 are arranged to be spaced apart from each other along the Y-axis direction. The plurality of first vertical areas 415 is arranged to be spaced apart from each other along the Z-axis direction. The plurality of second vertical areas 425 is also arranged to be spaced apart from each other along the Z-axis direction. The plurality of first vertical areas 415 is also arranged in the inlet surface through which unpurified air is suppled. The plurality of second vertical areas 425 is arranged in the outlet surface through which purified air is discharged.

The plurality of horizontal areas 410 corresponds to walls of the first groove 110 and the second groove 120. Each of the plurality of horizontal areas 410 is disposed between the first groove 110 and the second groove 120 to constitute a boundary between the first groove 110 and the second groove 120. The wall corresponds to side walls of the first groove 110 and the second groove 120. Thicknesses of the plurality of horizontal areas 410 are the same or different. Thicknesses of the plurality of horizontal areas 410 are the same as or different from those of the plurality of vertical areas 415 and 425. The horizontal areas 410 serving as walls of the first groove 110 are aligned in the Z-axis direction to be spaced apart from each other by a first distance D1. The horizontal areas 410 serving as walls of the second groove 120 are aligned in the Z-axis direction to be spaced apart from each other by a second distance D2. The first distance D1 is the same as or different from the second distance D2. Diameters and/or areas of inlets of the first groove 110 and the second groove 120 are the same or different. Lengths L1 of the plurality of horizontal areas 410 in the Y-axis direction are the same or different. Depths of the first groove 110 and the second groove 120 are defined by the length L1 of the horizontal area 410 in the Y-axis direction. Depths of the first groove 110 and the second groove 120 are the same or different. The plurality of first vertical areas 415 constitutes the bottoms of the second grooves 120. The plurality of second vertical areas 425 constitutes the bottoms of the first grooves 110. Air permeability of the bottom of the first groove 110 is the same as or different from that of the bottom of the second groove 120. A diameter D11 of the first vertical area 415 is the same as or different from a diameter D22 of the second vertical area 425. Thicknesses of the first vertical area 415 and the second vertical area 425 in the Y-axis direction are the same or different. The composite catalyst filter 100 may further include a plurality of first opposite surfaces 110B corresponding to the plurality of first surfaces 110S, and a plurality of second opposite surfaces 120B corresponding to the plurality of second surfaces 120S.

At least one catalyst layer including particles of at least two types of catalyst is disposed on the surface of the porous filter substrate, and the particles of at least two types of catalyst may contact each other in the catalyst layer.

The photocatalyst particles may include particles of at least one of TiO₂, ZnO, AgO, Ag₂O, CuO, ZrO₂, SnO₂, V₂O₃, WO₃, CdS, SrTiO₃, BiVO₄, Fe₂O₃, SiO₂, BaTiO₃, Fe₂O₃, Fe₃O₄, Ta₂O₃, and Nb₂O₅. In an embodiment, the photocatalyst particles may include particles of at least one of TiO₂, ZnO, AgO, Ag₂O, CuO, ZrO₂, SnO₂, V₂O₃, WO₃, Fe₂O₃, SiO₂, Fe₂O₃, Fe₃O₄, Ta₂O₃, and Nb₂O₅, for example.

the particles of the adsorbent and the oxidation catalyst may be a supported catalyst including a support and a transition metal supported on a surface of and partially inside the support, and the support may include at least one selected from zeolite, TiO₂, SiO₂, Al₂O₃, graphene, activated carbon, and a metal organic framework (“MOF”). The transition metal may be used as an active site for oxidation of pollutants in the air. In embodiments, the transition metal include Pt, Pd, Ag, Mn, Ni, or Zn.

The catalyst particles may have a particle diameter of 10 nanometers (nm) to 10 micrometers (μm). In an embodiment, the particle diameter of the catalyst particles may be from 10 nm to 9 μm, from 10 nm to 8 μm, from 10 nm to 7 μm, from 10 nm to 6 μm, from 10 nm to 5 μm, from 10 nm to 4 μm, from 10 nm to 3 μm, from 10 nm to 2 μm, or from 10 nm to 1 μm, for example. Particle diameters of catalyst particles may be measured using a particle size analyzer, a transmission electron microscopy (“TEM”) image, or a scanning electron microscopy (“SEM”) image. In an alternative embodiment, the particle diameters may be easily obtained by measurement with a device using dynamic light-scattering, counting the number of particles within each particle diameter range by analyzing data, and calculating the particle diameters therefrom. When the particle diameters of the catalyst particles are within the above-described range, a catalyst layer having a desired predetermined area may be obtained.

In the composite catalyst filter in an embodiment, a catalyst layer including a blend of particles of a photocatalyst, and particles of at least one type of adsorbent and oxidation catalyst may be disposed on the surface of the porous filter substrate. Because the catalyst layer is coated on the first and second surfaces of the porous filter substrate in a state where particles of the photocatalyst and particles of at least one type of adsorbent and oxidation catalyst are blended in the composite catalyst filter, the particles of the photocatalyst are activated in one region where energy is supplied to generate electrons and holes, and thus oxidation/reduction occur. At the same time, the particles of the adsorbent and/or the oxidation catalyst are activated in the other region where energy is not supplied, and thus adsorption and/or oxidation occur. Therefore, the air pollutant removal rate of the composite catalyst filter increases.

A weight ratio of the particles of the photocatalyst to the particles of at least one type of adsorbent and oxidation catalyst may be from about 2:8 to about 8:2. In an embodiment, the weight ratio of the particles of the photocatalyst to the particles of at least one type of adsorbent and oxidation catalyst may be from about 3:7 to about 7:3, from about 3.5:6.5 to about 6.5:3.5, or from about 3.3:6.7 to about 6.7:3.3. In the case where the weight ratio of the particles of the photocatalyst to the particles of at least one type of adsorbent and oxidation catalyst is within the above-described ranges, the air pollutant removal rate may further be increased.

In the composite catalyst filter in an embodiment, at least two catalyst layers are disposed on the surface of the porous filter substrate, and the catalyst layers include a first layer in which the particles of at least one type of adsorbent and oxidation catalyst are disposed, and a second layer in which the particles of the photocatalyst are disposed. The pollutants in the air are brought into contact with the particles of at least one type of adsorbent and oxidation catalyst disposed on the first and second surfaces close to an air inflow side in a region of the composite catalyst filter where energy is not supplied and are brought into contact with the particles of the photocatalyst disposed close to the energy source in a region where energy is supplied. Because the region to which energy is supplied is narrower than the region to which energy is not supplied, an area of the second layer coated on the first and second surfaces of the porous filter substrate is narrower than an area of the first layer. As a result, most of the particles of at least one type of adsorbent and oxidation catalyst and the particles of the photocatalyst are activated in the composite catalyst filter.

The catalyst layer may have a thickness of about 100 nm to about 100 μm. In an embodiment, the thickness of the catalyst layer may be from about 100 nm to about 90 μm, from about 100 nm to about 80 μm, from about 100 nm to about 70 μm, from about 100 nm to about 60 μm, from about 100 nm to about 50 μm, from about 100 nm to about 40 μm, from about 100 nm to about 30 μm, from about 100 nm to about 20 μm, or from about 100 nm to about 10 μm, for example. With the thickness of the catalyst layer within the above-described ranges, the air pollutant removal rate may increase.

The composite catalyst filter may be used to remove C1-C6 hydrocarbon compounds or nitrogen compounds. In embodiments, the C1-C6 hydrocarbon compounds may be volatile organic compounds (“VOCs”) such as 1,3-butadiene, benzene, formaldehyde (HCHO), acetaldehyde, ethylbenzene, toluene, acetic acid, or n-hexane. In embodiments, the nitrogen compounds may include nitrogen oxides (NOx, where 0<x≤6), ammonia, or urea.

A composite catalyst filter in another embodiment is a composite catalyst filter for removing pollutants from air including the pollutants and includes a porous filter substrate, and particles of at least one type of adsorbent and oxidation catalyst and particles of a photocatalyst disposed on a surface of the porous filter substrate to be capable of coming into contact with the pollutants of air.

A filtering system in another embodiment includes the above-described composite catalyst filter, and a light source configured to activate the catalysts of the composite catalyst filter.

The light source may emit light energy in a range from ultraviolet light to visible light. A separate energy source to activate the oxidation catalyst is not desired for the composite catalyst filter. However, an energy source capable of increasing temperature may be additionally included therein to promote activation of the oxidation catalyst. In embodiments, the energy source may include electrical energy, ion energy, thermal energy, or any combination thereof. The ion energy may be plasma. Infrared light may be supplied as thermal energy.

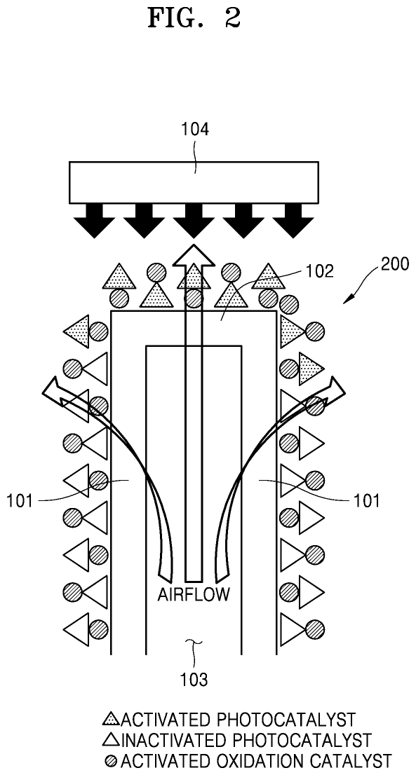

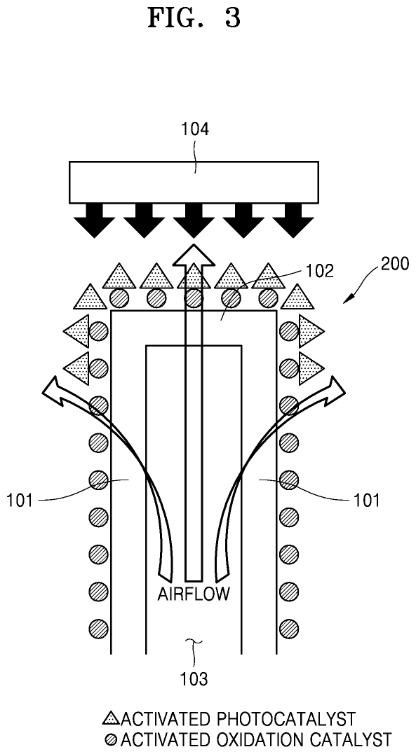

FIG. 2 is a schematic diagram of an embodiment of a filtering system including a composite catalyst filter. FIG. 3 is a schematic diagram of another embodiment of a filtering system including a composite catalyst filter.

Referring to FIGS. 2 and 3, the filtering system includes a composite catalyst filter 200 and an energy source 104 configured to supply energy.

The composite catalyst filter 200 of FIG. 2 includes a porous filter substrate including a first surface 101 parallel to an air inflow direction, and a second surface 102 perpendicularly in contact with the first surface 101. A groove 103 having an inlet at one side through which air is introduced is defined in the composite catalyst filter 200. The composite catalyst filter 200 further includes the catalyst layer including particles of at least two types of catalyst and formed on the first surface 101 and the second surface 102 of the porous filter substrate. The catalyst layer includes a blend of particles of the photocatalyst, and particles of at least one type of adsorbent and oxidation catalyst. The particles of at least one type of adsorbent and oxidation catalyst disposed on the first surface 101 and the second surface 102 of the composite catalyst filter 200 of FIG. 2 participate in adsorption and/or oxidation in the case of contacting air having passed through the first surface 101 and the second surface 102 from the groove 103. Also, in the composite catalyst filter 200 of FIG. 2, upon receiving energy emitted from the energy source 104, particles of the photocatalyst disposed on the second surface 102 close to the energy source 104 and disposed on a portion of the first surface 101 close to the second surface 102 participate in oxidation/reduction generating electrons and holes when brought into contact with air having passed through the first surface 101 and the second surface 102 from the groove 103. Therefore, the composite catalyst filter 200 may have an increased air pollutant removal rate partially by photocatalytic reaction and adsorption and/or oxidation. However, the particles of the photocatalyst disposed on the first surface 101 far from the second surface 102 of the composite catalyst filter 200 of FIG. 2 are not activated and cannot participate in the catalytic reaction.

The composite catalyst filter 200 of FIG. 3 includes a first layer in which particles of at least one type of adsorbent and oxidation catalyst are disposed, the first layer being disposed on the first surface 101 and the second surface 102 of the porous filter substrate; and a second layer in which particles of the photocatalyst are disposed, the second layer being disposed on the first layer, and the second layer is disposed to face the energy source 104. In the same manner as shown in FIG. 2, the particles of at least one type of adsorbent and oxidation catalyst disposed on the first surface 101 and the second surface 102 of the composite catalyst filter 200 of FIG. 3 participate in adsorption and/or oxidation in the case of contacting air. In the composite catalyst filter 200 of FIG. 3, upon receiving energy from the energy source 104, particles of the photocatalyst disposed on the second surface 102 close to the energy source 104 and disposed on a portion of the first surface 101 close to the second surface 102 participate in oxidation/reduction generating electrons and holes when brought into contact with air. However, because energy is supplied to a narrow region, an area of the second layer occupied by the particles of the photocatalyst is narrower than an area of the first layer occupied by the particles of at least one type of adsorbent and oxidation catalyst. However, because most of the particles of at least one type of adsorbent and oxidation catalyst of the first layer and the particles of the photocatalyst of the second layer are activated, the air pollutant removal rate may be efficiently increased.

The composite catalyst filters 200 of FIGS. 2 and 3 may have C1-C6 hydrocarbon compound removal rates of 80% or more, according to Equation 1 below, after filtering:

$$C 1 - C 6 hydrocarbon compound removal rate \text{} ( \% ) = [ \text{} \{ ( input amount of C 1 - C 6 hydrocarbon compound ) - ( residual amount of C 1 - C 6 hydrocarbon compound after 2 hours ( ppm ) \} \text{} / ( input amount of C 1 - C 6 hydrocarbon compound ( ppm ) ) ] \times 100 ( \% ) \qquad [ Equation 1 ]$$

As noted above in Equation 1, the input amount of C1-C6 hydrocarbon compound and the input amount of C1-C6 hydrocarbon compound may be measured in term of parts per million (ppm).

An air purifier in another embodiment may include the above-described composite catalyst filter.

The air purifier may include a catalyst module including the above-described composite catalyst filter. The catalyst module may include the above-described composite catalyst filter and a light emitter disposed to emit light, as energy for activating the catalyst, to the composite catalyst filter. The light emitter may include a light source array including a single light source or multiple light sources. The light emitter may include a substrate, a light-emitting device disposed on the substrate, and a capsule sealing and protecting the light-emitting device. The light-emitting device may be an ultraviolet light-emitting diode (“UV-LED”). The substrate may include a controller configured to control the operation of the light-emitting device, e.g., a circuit device. The capsule may be formed on the substrate to cover the entirety of the light-emitting device on the substrate. The capsule may include or consist of a transparent material to light emitted from the light-emitting device. The catalyst module may further include a circulating fan disposed to face the opposite side of the composite catalyst filter provided with the light emitter. The light emitter and the circulating fan are connected to a power source. While the catalyst module operates, the light emitter emits light to a surface of the composite catalyst filter facing the light emitter, and the emitted light is absorbed by the composite catalyst filter to activate a photocatalyst layer on the surface. On a surface in contact with air introduced by the circulating fan, an activated oxidation catalyst layer may be formed. The activated photocatalyst and oxidation catalyst layers may degrade the pollutants in the air by photolysis and oxidation.

In the air purifier, a gas inlet and a gas outlet are installed at one side and another side parallel to the one side and the above-described catalyst module may be disposed (e.g., mounted) therein such that a circulating fan is disposed at the side where the gas outlet is disposed.

An air purification system in another embodiment may include the above-described air purifier.

The air purification system may include a supply device configured to supply air including gaseous pollutants; and an air purifying device disposed (e.g., mounted) with the above-described catalyst module configured to degrade the gaseous pollutants contained in the air supplied from the supply device and discharge the air from which the pollutants are removed. The air purification system may further include an analysis device configured to measure types and concentrations of the pollutants in the air, such as C1-C6 hydrocarbon compounds and/or nitrogen compounds, in the air purifying device. In embodiments, the analysis device may include an IR analyzer, a spectroscope, or the like. The analysis device is connected to the air purifying device.

The supply device may include an air supplier configured to supply pollutant-including or consisting of air and a controller configured to detect an airflow discharged from the air supplier and control an amount thereof.

A method of preparing the above-described composite catalyst filter in another embodiment may include providing a porous filter substrate; preparing an oxidation catalyst coating solution and a photocatalyst coating solution, respectively; coating the porous filter substrate with the oxidation catalyst coating solution and the photocatalyst coating solution by immersing the porous filter substrate in the oxidation catalyst coating solution and the photocatalyst coating solution; and drying and heat-treating the porous filter substrate coated with coating solutions.

According to the method of preparing a composite catalyst filter, a composite catalyst filter having an increased air pollutant removal rate may be easily prepared by coating the surface of the porous filter substrate with a catalyst layer including a blend of the oxidation catalyst particles and the photocatalyst particles by immersing the porous filter substrate in the blend of the oxidation catalyst coating solution and the photocatalyst coating solution, or by coating the surface of the porous filter substrate with an oxidation catalyst particle layer and a photocatalyst particle layer by sequentially immersing the porous filter substrate in the oxidation catalyst coating solution and the photocatalyst coating solution.

The oxidation catalyst coating solution and the photocatalyst coating solution are prepared by adding the oxidation catalyst particles and the photocatalyst particles in organic solvents.

The preparing of the oxidation catalyst coating solution may include acid-treating a support and immersing the acid-treated support with transition metals.

In the preparing of the oxidation catalyst coating solution, a support including at least one selected from zeolite, TiO₂, SiO₂, Al₂O₃, graphene, activated carbon, and MOF may be treated with an acid such as HNO₃, H₂SO₄, or H₃PO₄. By the acid treatment, the surface of the support becomes hydrophilic upon contact with pollutants in the air, e.g., VOCs, to further increase a degree of activation of the transition metal, and thus the removal rate of various VOCs may further be increased. The acid treatment may be performed by immersing the support in an acid solution at room temperature for about 12 hours to about 36 hours. A transition metal, such as Pt, Pd, Ag, Mn, Ni, or Zn is immersed in the acid-treated support to prepare the oxidation catalyst coating solution.

The drying may be performed, e.g., in a vacuum oven at a temperature of about 70 degrees Celsius (° C.) to about 100° C., and the heat-treating may be performed, e.g., in a furnace at a temperature of about 400° C. to about 800° C. By these drying and heat-treating processes, a uniform catalyst layer including the oxidation catalyst particles and the photocatalyst particles may be formed on the surface of the porous filter substrate.

Hereinafter, the disclosure will be described in more detail with reference to the following examples and comparative examples. However, the following examples are merely presented to exemplify the disclosure, and the scope of the disclosure is not limited thereto.

### EXAMPLES

### Example 1: Composite Catalyst Filter

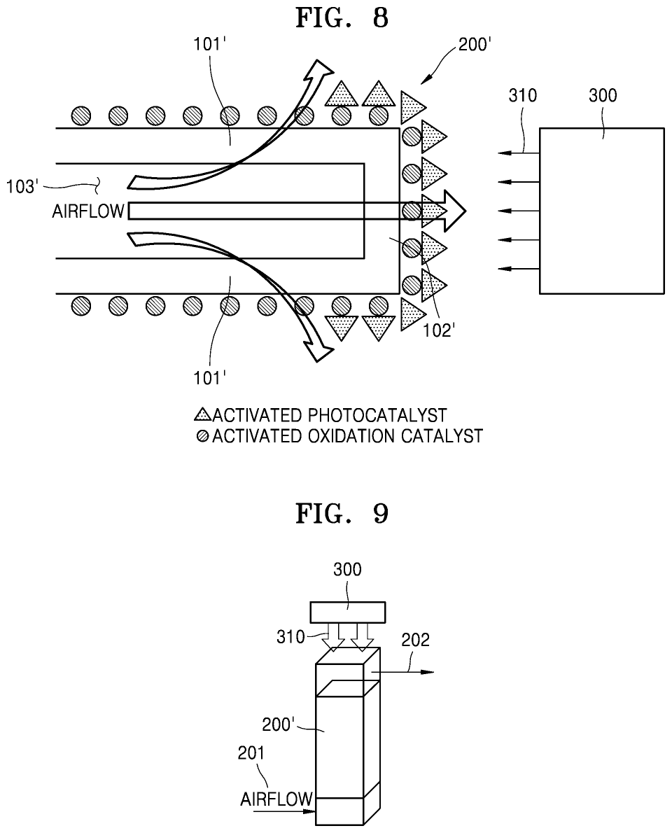

A composite catalyst filter 200′ as shown in FIG. 8 was prepared as follows.

First, a ceramic filter substrate was prepared. A Cordierite ceramic material (porosity: 30%) filter including a first surface 101′ parallel to an air inflow direction, a second surface 102′ perpendicularly in contact with the first surface, and a groove 103′ having an inlet at one side through which air is introduced and having a size of 38 millimeters (mm)×38 mm×110 mm was prepared.

Separately, an oxidation catalyst coating solution was prepared. Zeolite (HZSM-5, SiO₂/Al₂O₃=280, particle diameter=(5 μm)) obtained by heat-treating CBV 28014 (Zeolyst) at 550° C. for 5 hours was acid-treated in 70% HNO₃ for 24 hours, and H₂PtCl₆ was supported thereon by wet impregnation to obtain an oxidation catalyst in which Pt was supported on a zeolite support. The oxidation catalyst was mixed with water as a solvent to prepare an oxidation catalyst coating solution in which Pt was supported on a zeolite support.

A photocatalyst coating solution was prepared. TiO₂ (Ishihara, ST-01, particle diameter=5 μm) as a photocatalyst was mixed with water as a solvent to prepare a TiO₂ coating solution.

The ceramic material (porosity: 30%) filter was immersed in the oxidation catalyst coating solution to a depth of about 100 mm in a direction from the second surface 102′ to the first surface 101′ to form an oxidation catalyst layer, as a first layer, (thickness: about 1 μm) including 1.72 grams (g) of the oxidation catalyst in which Pt was supported on the zeolite support. Subsequently, the ceramic material filter was immersed in the photocatalyst coating solution to a depth of about 50 mm in a direction from the second surface 102′ to the first surface 101′ to form a second layer (thickness: about 4 μm) including 2.77 g of the TiO₂ photocatalyst, thereby obtaining a composite catalyst filter coated with a double-layer catalyst. The composite catalyst filter coated with the double-layer catalyst was dried in a vacuum oven at 80° C. for 24 hours to prepare a composite catalyst filter 200′.

### Comparative Example 1: Photocatalyst Filter

A photocatalyst filter was prepared in the same manner as in Example 1, except that the ceramic material (porosity: 30%) filter was immersed in the TiO₂ photocatalyst coating solution to a depth of about 50 mm in a direction from the second surface 102′ to the first surface 101′ to form a photocatalyst layer (thickness: about 4 μm) including 2.85 g of TiO₂ photocatalyst.

### Comparative Example 2: Oxidation Catalyst Filter

An oxidation catalyst filter was prepared in the same manner as in Example 1, except that the ceramic material (porosity: 30%) filter was immersed in the oxidation catalyst coating solution in which Pt was supported on the zeolite support to a depth of about 100 mm in a direction from the second surface 102′ to the first surface 101′ to form an oxidation catalyst layer (thickness: about 1 μm) including 1.72 g of the oxidation catalyst in which Pt was supported on the zeolite support.

### Evaluation Example 1: Evaluation of HCHO Removal Rate

An experiment for evaluating HCHO removal rates was performed on the composite catalyst filter prepared in Example 1, the photocatalyst filter prepared in Comparative Example 1, and the oxidation catalyst filter prepared in Comparative Example 2. The results are shown in Table 1.

The experiment for evaluating the HCHO removal rate of the composite catalyst filter prepared in Example 1 was performed by installing the composite catalyst filter 200′ prepared in Example 1 and a 365 nm UV LED light source (Fiber Optics Korea Co) as an energy source 300 in a flow system as shown in FIG. 9. A groove 103′ of the composite catalyst filter 200′ prepared in Example 1 was arranged to be parallel to an inlet 201 of an air inflow side, and the second surface 102′ was arranged to face the 365 nm UV LED light source (Fiber Optics Korea Co), as the energy source 300, to receive energy 310 supplied thereby. HCHO-containing air (HCHO, 20% 02, 80% N₂) was introduced to the inlet 201 of the air inflow side using a pressure at a flow rate of 26 L/min at a HCHO content of 13.01 ppm and purified air was discharged through an outlet 202. In this regard, after 2 hours at 25° C. with a relative humidity of 30%, a residual amount of HCHO in a chamber was measured to evaluate a HCHO removal rate after filtering as shown in Equation 1-1 below.

$$HCHO removal rate ( \% ) = [ \{ ( input amount of HCHO ) - residual amount of HCHO ( ppm ) after 2 hours \} \text{} / ( input amount of HCHO ( ppm ) ) ] \times 100 ( \% ) \qquad [ Equation 1 - 1 ]$$

An experiment for evaluating HCHO removal rates of the photocatalyst filter prepared in Comparative Example 1 and the oxidation catalyst filter prepared in Comparative Example 2 was conducted in the same manner as in the experiment for evaluating HCHO removal rates of the composite catalyst filter prepared in Example 1, except that input amounts of the HCHO were 10.37 ppm and 9.72 ppm, respectively.

TABLE 1

| | | | | | Residual | |
|---|---|---|---|---|---|---|
| | | Coating | | | amount of | |
| | | amount | | Input | HCHO | HCHO |
| | | of | Coating | amount of | after 2 | removal |
| | Catalyst | catalyst | depth | HCHO | hours | rate |
| | layer | (g) | (mm) | (ppm) | (ppm) | (%) |
| Example 1 | First layer of | 1.72 | 100 | 13.01 | 0.445 | 96.60 |
| | oxidation | | | | | |
| | catalyst | | | | | |
| | Second layer | 2.77 | 50 | | | |
| | of | | | | | |
| | photocatalyst | | | | | |
| Comparative | Photocatalyst | 2.85 | 50 | 10.37 | 2.76 | 73.40 |
| Example 1 | layer | | | | | |
| Comparative | Oxidation | 1.72 | 100 | 9.72 | 2.12 | 78.20 |
| Example 2 | catalyst layer | | | | | |

As shown in Table 1, the composite catalyst filter prepared in Example 1 had a higher HCHO removal rate than those of the photocatalyst filter prepared in Comparative Example 1 and the oxidation catalyst filter prepared in Comparative Example 2 by about 18% to about 24%.

This indicates that, in the composite catalyst filter prepared in Example 1, the HCHO-containing air introduced via the inlet of the air inflow side is brought into contact with the oxidation catalyst particles disposed on the first surface and the second surface after passing through walls of the first and second surfaces from the inside of the groove and brought into contact with the photocatalyst particles disposed on the second surface close to the 365 nm UV LED light source as an energy source. As a result, it is considered that almost all of the particles of the oxidation catalyst and the photocatalyst of the composite catalyst filter prepared in Example 1 were activated and thus the HCHO removal rate from the HCHO-containing air was increased.

On the contrary, it is considered that because only the particles of the photocatalyst disposed on the second surface to which energy is suppled from the 365 nm UV LED light source are activated in the photocatalyst filter prepared in Comparative Example 1, the HCHO removal rate thereof was lower than that of the composite catalyst filter prepared in Example 1. It is considered that because the catalyst particles are activated only by oxidation in the oxidation catalyst filter prepared in Comparative Example 2, the HCHO removal rate thereof was lower than that of the composite catalyst filter prepared in Example 1 in which the catalyst particles were activated by oxidation and photocatalytic reaction.

The composite catalyst filter in an embodiment includes particles of at least one type of catalyst on the surface of the porous filter substrate, and the catalyst particles include particles of the photocatalyst, and particles of at least one type of adsorbent and oxidation catalyst. Because air passes through walls, i.e., the first and second surfaces, of the porous filter substrate in the composite catalyst filter, a relatively large contact area between the particles of the photocatalyst and particles of the adsorbent and/or the oxidation catalyst disposed thereon, may be obtained, and the catalyst particles may simultaneously participate in photocatalytic reaction and adsorption and/or oxidation. Therefore, the composite catalyst filter has an increased air pollutant removal rate.

It should be understood that embodiments described herein should be considered in a descriptive sense only and not for purposes of limitation. Descriptions of features or advantages within each embodiment should typically be considered as available for other similar features or advantages in other embodiments. While embodiments have been described with reference to the drawing figures, it will be understood by those of ordinary skill in the art that various changes in form and details may be made therein without departing from the spirit and scope as defined by the following claims.

What is claimed is:

1. A composite catalyst filter comprising:
a porous filter substrate; and
particles of at least one type of catalyst on a surface of the porous filter substrate, the particles of the catalyst comprising:
particles of a photocatalyst, and
particles of at least one type of adsorbent and oxidation catalyst.

2. The composite catalyst filter of claim 1, wherein the porous filter substrate has a porosity of about 5% to about 90%.

3. The composite catalyst filter of claim 1, wherein the porous filter substrate has an air-permeable wall through which air passes.

4. The composite catalyst filter of claim 1, wherein at least one catalyst layer comprising particles of at least two types of catalyst are disposed on a surface of the porous filter substrate, and
the particles of the at least two types of the catalyst contact each other in the at least one catalyst layer.

5. The composite catalyst filter of claim 1, wherein the particles of the photocatalyst comprise particles of at least one of TiO₂, ZnO, AgO, Ag₂O, CuO, ZrO₂, SnO₂, V₂O₃, WO₃, CdS, SrTiO₃, BiVO₄, Fe₂O₃, SiO₂, BaTiO₃, Fe₂O₃, Fe₃O₄, Ta₂O₃, and Nb₂O₅.

6. The composite catalyst filter of claim 1, wherein the particles of the adsorbent and the oxidation catalyst are a supported catalyst comprising a support and a transition metal supported on a surface of and partially inside the support, and
the support comprises at least one selected from zeolite, TiO₂, SiO₂, Al₂O₃, graphene, activated carbon, and a metal organic framework (“MOF”).

7. The composite catalyst filter of claim 1, wherein the particles of the catalyst have a particle diameter of about 10 nanometers to about 10 micrometers.

8. The composite catalyst filter of claim 1, wherein a catalyst layer comprising a blend of the particles of the photocatalyst and the particles of the at least one type of the adsorbent and the oxidation catalyst is disposed on the porous filter substrate.

9. The composite catalyst filter of claim 1, wherein a weight ratio of the particles of the photocatalyst to the particles of the at least one type of the adsorbent and the oxidation catalyst is from about 2:8 to about 8:2.

10. The composite catalyst filter of claim 1, wherein at least two catalyst layers are disposed on the surface of the porous filter substrate,
wherein the catalyst layers comprise: a first layer in which the particles of the at least one type of the adsorbent and the oxidation catalyst are disposed; and
a second layer in which the particles of the photocatalyst are disposed.

11. The composite catalyst filter of claim 8, wherein the catalyst layer has a thickness of about 100 nanometers to about 100 micrometers.

12. The composite catalyst filter of claim 1, wherein the composite catalyst filter removes C1-C6 hydrocarbon compounds or nitrogen compounds.

13. A filtering system comprising:
a composite catalyst filter; and
a light source configured to activate a catalyst of the composite catalyst filter, the composite catalyst filter comprising:
a porous filter substrate; and
particles of at least one type of catalyst on a surface of the porous filter substrate, the particles of the catalyst comprising:
particles of a photocatalyst, and
particles of at least one type of adsorbent and oxidation catalyst.

14. The filtering system of claim 13, wherein the porous filter substrate comprises a first surface parallel to an air inflow direction, and a second surface perpendicularly in contact with the first surface,
a groove having an inlet at one side through which air is introduced is defined in the porous filter substrate, and
the composite catalyst filter further comprises a catalyst layer comprising particles of at least two types of catalyst and formed on the first and second surfaces of the porous filter substrate.

15. The filtering system of claim 14, wherein the composite catalyst filter comprises:
a first layer in which the particles of the at least one type of the adsorbent and the oxidation catalyst are disposed, the first layer being disposed on the first and second surfaces of the porous filter substrate; and
a second layer in which particles of the photocatalyst are disposed, the second layer being disposed on the first layer,
wherein the second layer faces the light source.

16. The filtering system of claim 15, wherein the second layer has a narrower area than the first layer.

17. The filtering system of claim 13, wherein the filtering system has a C1-C6 hydrocarbon compound removal rate according to Equation 1 below after filtering of 80% or more:
$$C 1 - C 6 hydrocarbon compound removal rate \text{} ( \% ) = [ \text{} \{ ( input amount of C 1 - C 6 hydrocarbon compound ) - ( residual amount of C 1 - C 6 hydrocarbon compound after 2 hours ( in terms of parts per million ) \} \text{} / ( input amount of C 1 - C 6 hydrocarbon compound ( in terms of parts per million ) ) ] \times 100 ( \% ) . \qquad [ Equation 1 ]$$

18. A composite catalyst filter for removing pollutants from pollutant-containing air, the composite catalyst filter comprising:
a porous filter substrate; and
particles of at least one type of adsorbent and oxidation catalyst and particles of a photocatalyst, disposed on a surface of the porous filter substrate to be capable of coming into contact with the pollutants in the air.
